(19) United States
(12) Patent Application Publication
(10) Pub. No.: US 2019/0205958 A1
(43) Pub. Date: Jul. 4, 2019

(54) Transactional digital platform (mobile,web and virtual/augmented reality devices) that allows fans to purchase tailored videos from the video creators and stars they adore while benefitting charities

(71) Applicant: Nikki Fuyala, Summit, NJ (US)

(72) Inventor: Nikki Fuyala, Summit, NJ (US)

(21) Appl. No.: 15/859,664

(22) Filed: Dec. 31, 2017

(51) Int. Cl. G06Q 30/06

(52) U.S. Cl. CPC G06Q 30/0621

(57) ABSTRACT

The system uses an application for a transactional marketplace connecting two groups of people, Creators who are celebrities and Consumers who are fans that place a value on short tailored videos. The Creator has the ability to build and define exactly what these offerings are. All users download the app or visit the website and identify themselves as either someone looking for an experience or a Creator who is willing to create a personalized video offering.

### CROSS-REFERENCES TO RELATED APPLICATIONS (IF ANY) None

### BACKGROUND

### 1. Field of the Invention

The present invention relates to a process that allows fans to purchase tailored videos and from the video creators and stars they adore, while benefitting charities and more particularly one that is used with electronic devices.

### 2. Description of Prior Art

Creators and stars are always looking for new and better ways to provide personal services and videos to their fans.

U.S. Pat. No. 9,681,159 by Jain, et al. and issued on Jun. 13, 2017 is for a process for creating audience segments for campaigns. It discloses creating audience segments for campaigns is described. In one or more embodiments, an audience manager is configured to create, for one or more videos, a video audience segment associated with the video by storing, in a data management platform, user identifiers of users that viewed the video. The user identifiers can be received from a client player each time that a video is played at the client player. The audience manager is further configured to extract demographic information from a demographic report associated with the video that is received from a demographics provider, and to associate the demographic information with the video audience segment. The audience manager is further configured to generate a target audience segment for a campaign by merging and combining user identifiers that are included in two or more video audience segments.

U.S. Pat. No. 9,583,142 by Zhu, et al. and issued on Feb. 28, 2017 is for a social media platform for creating and sharing videos. It discloses systems, media, methods, and platforms providing video processing for generating and sharing lip-sync videos comprising: presenting an interface allowing a user to select audio content; presenting an interface allowing a user to capture video content; presenting an interface allowing a user to synchronize the audio content with the video content; synthesizing the video content and the audio content to generate a new lip-sync video; automatically sharing the lip-sync video to a social media platform; and providing a lip-sync video feed within a social network.

U.S. Pat. No. 9,380,338 by Vestergaard, et al. and issued on Jun. 28, 2016 is for a script-based video rendering. It discloses systems and methods for cross-platform rendering of video content on a user-computing platform that is one type of a plurality of different user-computing platform types. A script is transmitted to the user-computing platform and is interpreted by an application program compiled to operate on any one of the plurality of user-computing platform types. A series of frame images is encoded to provide the encoded video data. Encoding the frame images comprises encoding the frame images into a content-transfer format whereby the content-transfer encoded frame images can be passed by a script interpreter interpreting the script to the application program. The encoded video data is transmitted to the user-computing platform. The script is further configured to cause the script to be interpreted by the application program to: decode the transmitted encoded video data into decoded video data comprising the content-transfer encoded frame images; and render the decoded video data by displaying the frame images.

U.S. Pat. No. 9,143,826 by Vestergaard, et al. and issued on Sep. 22, 2015 is for script-based video rendering using alpha-blended images. It discloses systems and methods for cross-platform rendering of video content on a user-computing platform that is one type of a plurality of different user-computing platform types. A script is transmitted to the user-computing platform and is interpreted by an application program compiled to operate on any one of the plurality of user-computing platform types. Transmitting the script causes the script to be interpreted by the application program operating on the user-computing platform to cause the interpreted script to directly decode encoded video data transmitted or otherwise accessible to the user-computing platform into decoded video data and to further cause the rendering of the decoded video data.

U.S. Pat. No. 9,032,298 by Segal, et al. and issued on May 12, 2015 is for a website application system for online video producers and advertisers. It discloses a system for accessing development components, including an online video clip library of templates and an online music clip library, and enabling online production of user-friendly, custom-integrated media products. The system includes a Web application on a Website for hosting services for producers/advertisers/users. The system also includes a search engine that indexes the video, interactive Web formatting screens for selecting development components and producing the Web products in said Web application, an online MIXER module for editing and playing said selected video, an online editing program, which allows the advertiser/user to edit his advertisement himself, outside Web Services accessible by said advertisers of said Web application via the internet for custom-integrating, encoding and formatting the video clips and a parallel platform in which content producer/users and commercial libraries could upload their raw material and set their price.

U.S. Pat. No. 8,799,071 by Gruber, et al. and issued on Aug. 5, 2014 is for personalized video generation. It discloses a personalized video generation system, including: (i) a digital asset manager for storing a video project file marked with references to content groups and content substitution rules; (ii) an editing tool for accessing the file and displaying content of the file grouped based on the groups, and generating an interface for substituting content across a video corresponding to the file, the interface adjusting the references for the digital asset manager; and (iii) a content generation engine for processing the file and the rules, based on personal data for intended recipients, to access content items and generating a plurality of video project files for rendering as corresponding videos for the recipients. The system can also include (iv) a distribution engine for communicating with a least one distribution gateway for a delivery platform; and (v) a least one render engine for receiving the video project files, causing rendering of the videos for a respective delivery platform, and forwarding the videos to the distribution engine for distribution of the videos for the respective delivery platform. It is assigned to QDC IP Technologies Pty Ltd (Adelaide, AU).

U.S. Pat. No. 8,307,392 by Ahanger, et al. and issued on Nov. 6, 2012 is for systems and methods for inserting ads during playback of video media. It discloses an ad delivery platform described herein provides for the marketing and monetizing of media assets via the delivery of advertisement with on-demand video. The ad platform optimizes the delivery of ads by controlling the insertion frequency and format of the ad delivered with video streams. The ad platform provides flexible and configurable ad insertion rules to specify the insertion frequency and format for the composition of ads during playback of on-demand video media. The ad insertion rules may be based on a user profile, user behavior history, topic of the stream to be delivered, duration of the video or ad, and/or the popularity rating of the video or ad. The ad platform includes a reporting tool and usage reports to measure the effectiveness of the ad insertion rules in delivering ads to market and monetize the video media. The ad platform also includes an ad inventory management and forecasting tool for determining the available inventory of ad placement based on data collected over a period of time regarding the delivery of ads and the ad insertion rules to be used for the delivery of a desired ad. With these tools, a more effective ad campaign can be created based on the target information and optimization via the ad insertion rules. It is assigned to Yahoo! Inc.

U.S. Pat. No. 8,761,580 by Gausereide and issued on Jun. 24, 2014 is for a real time video inclusion system. It discloses a process and system that allows an end user to insert images into a video content so that the images appear part of that content. This allows a consumer to seem to be part of a video, and interact with the famous personalities in that video. A video content is produced and a first software program is used to insert place holding templates into the video content. The end user produces a video image satisfying the requirements of the inserted template, and a second software program composites the two video streams so that the end user's video image is inserted into the first video content replacing the templates. The system can also be used to insert advertising information into a background to create custom, personalized, “on the fly” advertisements and product

United States Patent Application 20150106149 by TRAINA; et al. and published on Apr. 16, 2015 is for SYSTEMS AND METHODS OF PROCESSING INFORMATION AND TRANSACTIONS INVOLVING DIGITAL CONTENT AND/OR EXPERIENCES ASSOCIATED WITH CELEBRITIES AND NETWORKED USERS.

It discloses systems and methods for processing transactions and associated dated. In one exemplary implementation, there is provided a method for processing information associated with transactions involving a product, wherein the product may comprise an experience, a physical product, and/or a digital product. Moreover, illustrative methods may include performing processing associated with a plurality of subroutines, such as a first subroutine for handling an experience, a second subroutine for handling a physical and/or a digital product, and/or one more additional subroutines associated with fulfillment.

United States Patent Application 20160247195 by Hopper; et al. and published on Aug. 25, 2016 is for a social Media Experiential Platform System and Methods. It discloses a social media experiential platform and method for establishing the operation. The social media experiential platform comprises users, subscribers, and sponsors. Users capture digital images at an event hosted by a subscriber. Thereafter, the user can post the digital images to a plurality of social network providers and/or print digital images via various printing methods utilizing a unified interface. In some embodiments, there is no cost to the user for printing the digital images and the printing materials are provided to the subscriber at no cost. In turn, each post and/or print of a digital image includes a plurality of tags to promote a sponsor and/or subscriber. As a result, subscribers can generate social media awareness and visibility while offering users a unique service at no cost, and sponsors can reach a targeted, measurable audience via print, video display, and web advertising.

United States Patent Application 20090238538 by FINK and published on Sep. 24, 2009 is for a SYSTEM AND METHOD FOR AUTOMATED COMPILATION AND EDITING OF PERSONALIZED VIDEOS INCLUDING ARCHIVED HISTORICAL CONTENT AND PERSONAL CONTENT. It discloses a personalized video system that combines user-supplied data and digital visual images or view with stored archival stock video footage and popular music works of the last century to generate a personalized life story documentary movie. The personalized video system gathers input from the user about the recipient such as age, gender, and relationship to the user and allows the user to upload personal digital images or video of the recipient. The user then inputs the dates of each digital image or video uploaded so that the personalized video system can chronologically order the items in the video. The personalized video system combines the user-supplied information and digital media with archived stock video footage of significant events and famous personalities to place the recipient's life story in a historical context. The personalized video system also provides a music soundtrack and synchronizes the display of the digital media and archived footage to the selected soundtrack. One embodiment allows the user to upload birth certificates, marriage certificates, newspaper clippings or other digitally scanned material for use in the video. Another embodiment allows the user to record or upload a voiceover narrative, sound effects or other audio content.

There is still room for improvement in the art.

### SUMMARY OF THE INVENTION

she System has been created partially to address a gap in ongoing revenue from Social Media Personalities e.g. You Tubers, Instagrammers as well as emerging and ‘retired’ celebrities and public figures. Particularly, due to oversaturation of the market, nowadays it is becoming harder to create income from endorsements and advertising alone. The System will address this by creating both a new revenue platform as well as potentially a new/(re)branding channel for these Creators/Stars. It will allow them to sell personalized, tailored videos, fulfilling the requests of adoring fans.

The current invention is a system (websites and applications platform) for a transactional marketplace connecting two groups of people; 1. ‘Creators’ (like stars) who would like to drive supplementary income and/or support a chosen charity and 2. ‘Consumers’ (fans) who place value on short tailored personal video messages from their favorite Creators (Stars) s. The creator has the ability to build and define what these video offerings are e.g. a one minute personalized ‘Happy Birthday’ video for $55. Consumers can also directly request a unique customized video e.g. ‘How much would it cost for you to make a 5 minute video teaching my son John a new skateboarding trick?’. All users download the app or visit the website and would generally identify themselves as either someone looking for a video offering or a creator who is willing to create and sell such an offering.

Creators will input their profile information, select the charity they intend to support, build out their homepage/landing page and add video offerings along with a suggested fee. Consumers can then search for creators by category or name, linking to the Creator Homepage/landing page. Many consumers will access the ‘Creator Homepage/landing page’ from the Creator's social media accounts or YouTube page.

If a consumer chooses to purchase a video, they can request what details they would like to be included in their personal tailored video (via a written or a video request). The request and payment are submitted through the system and the creator chooses to accept or decline the request or suggest a separate fee. If they accept, they will produce and deliver the video as requested by the consumer. Payment to the creator is processed after the video has been delivered to the consumer with a fee kept for the system and donation for the selected charity .

The system, in the preferred embodiment, would be available through a website, smartphone and tablet applications, virtual reality device applications and augmented reality device applications.

The innovative process is unique and more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 shows an overview of the platform;

FIG. 3 shows a sample fee structure; and

FIG. 4 shows the request and payment process flow.

### DESCRIPTION OF THE PREFERRED EMBODIMENT

There are a number of significant design features and improvements incorporated within the invention.

The current invention is system 1, (available on websites and applications) a transactional marketplace connecting two groups of people; 1. ‘Creators’, (like stars), who would like to drive supplementary income and/or support a chosen charity and 2. ‘Consumers’ (fans) who place value on a short tailored video. The creator has the ability to build and define exactly what these video offerings are. Consumers can also directly request a unique customized video. All users download the app or visit the website and would generally identify themselves as either someone looking for an video offering or a creator who is willing to create and sell such an offering.

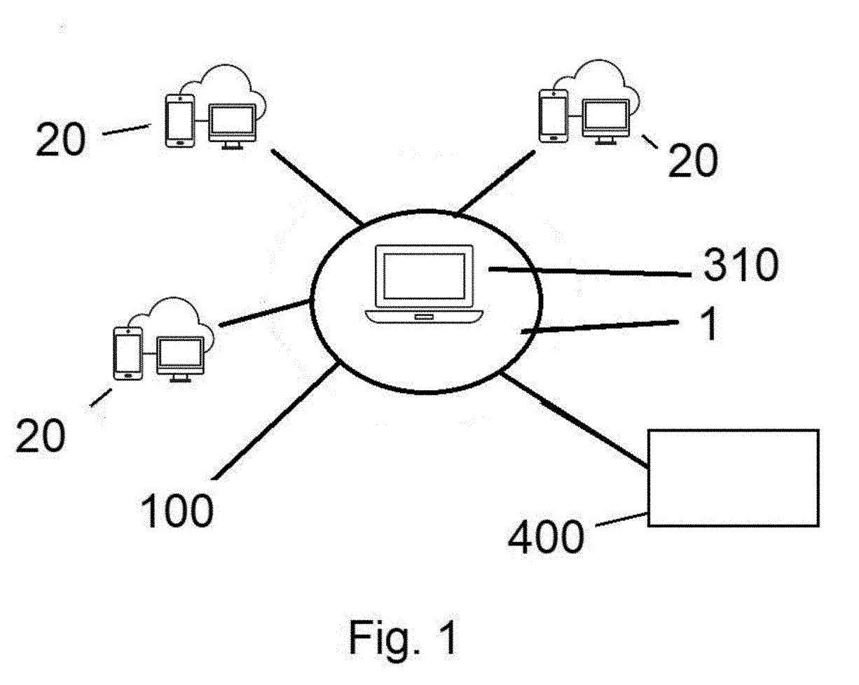

FIG. 1 displays the preferred embodiment of the system architecture 1 accessed through an Internet, Intranet and/or Wireless network 100. However, the system could be implemented on a device-to-device or client/server architecture as well.

In FIG. 1, the system 1 is accessed from a user's computing device 20 through a web browser over HTTP and/or HTTPS protocols 100 or wireless network or cell phone to cell phone connection. A computing device 20 that can access the system 1 must have some version of a CPU, CPU memory, local hard disk, keyboard/keypad/input and display unit. The computing device 20 can be a smart phone, desktop, laptop, tablet, virtual reality, augmented reality device or general purpose computing device with an appropriate amount of memory suitable for this purpose and an active connection to the Internet 100. Computing devices like this are well known in the art and are not pertinent to the invention.

The system 1, data and processing code can reside in the non-transitory memory 310 of the one or more computing devices. The system 1 in the preferred embodiment would be written to act like a smart phone application (app) where the different apps can communicate with each other. The system 1 may work with a central server as shown in FIG. 1 or in parallel with each smart phone 20 communicating with others within the system 1. The system 1 can be used with a website 400.

The system 1 in the preferred embodiment would be written to act like a smart phone and/or website application (app).

### Brief Overview

The system 1 is system 1 and application for a transactional marketplace connecting two groups of people. The groups are creators and consumers.

The creators would include all types of stars/celebrities , retired and working, such as YouTubers, Instagram Stars, Social Media Personalities, Sports Stars, Athletes, TV/Movie stars, Adult Entertainers, Musicians as well as those in Education, Arts & Politics. The system 1 can be used by the creators to connect with their fans and/or drive additional revenue for themselves and/or charities.

Consumers would include fans and followers who want to help the creators succeed, benefit charities and would love a personal video/interaction from them. It may also include those who would like to gift video/experiences to family, friends and colleagues for special occasions or for motivation.

The Creators can generate income by offering tailored video messages personalized for the Consumer. The creator has the ability to build and define what these offerings are. For the purposes of this application these offers will be referred to as ‘Video offerings’. All users would download the system 1 or application or visit the website 400 and may identify themselves as either someone looking for a video offering or a creator who is willing to create and sell a video offering .

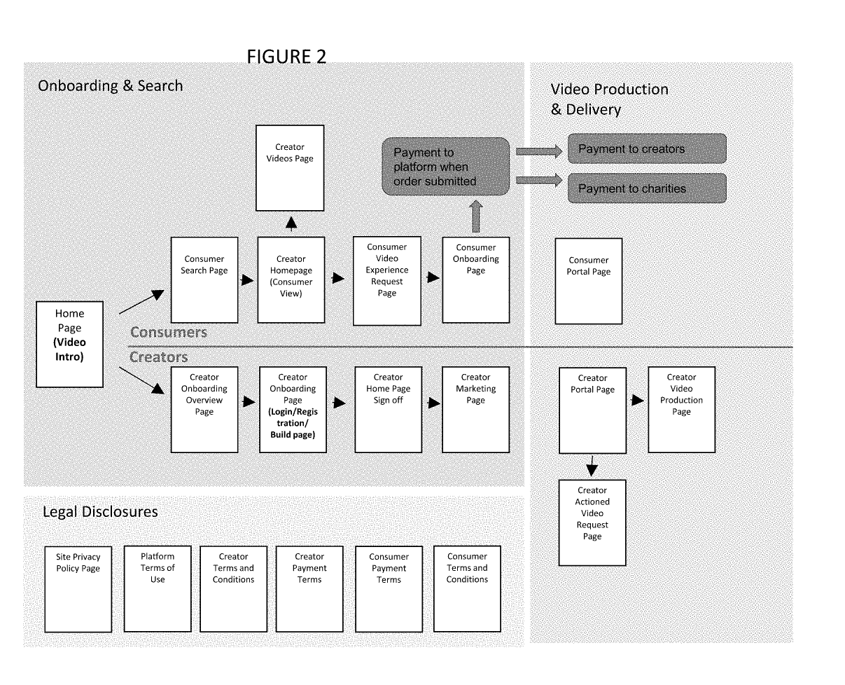

As shown in FIG. 2, the Creators will input their profile information and build out their homepage via the website 400 and add video offerings plus fees (Creator Onboarding pages). Consumers will access the Creator's homepage through social media links or directly from the main system Homepage where they can browse or search for creators by category or name or desired criteria.

### Creators

The System 1 would have a welcome (home) page in the preferred embodiment. The welcome page would give the creator an overview of the platform and be the gateway to the Creator Onboarding page. Onboarding would involve agreeing to terms and conditions, account registration, creating their own customized Home Page (Creator Home Page) which may include photos, videos, logos, descriptions, social media/website links. It will also include details and a logo of their chosen charity. Creators will be able to select their chosen charity and the percentage of the video fee that charity will receive. Creators can edit/customize their ‘Public Profile’ or Creator homepage at any time.

The System then allows Creators the ability to create a number of personalized video offerings with prices. They can explain their offerings through a short text and/or video description e.g. ‘I will make you a one minute personalized ‘Happy Birthday’ video for $55’. They will also be able to set parameters for each video offering e.g. ‘Typical Delivery Timeframe’ (turnaround time), price and any other special considerations. Creators will set fees/prices for each of their video offerings, however Consumers are able to pay over and above the asking amount if they so wish and request pricing for unique customized tailored video e.g. ‘How much would it cost for you to make a 5 minute video teaching my son John a new skateboarding trick?’

The System then allows the Creator to input details on how they would like to receive payment. The Creator can then ‘sign off’ on their Homepage and choose to ‘go live’. The System allows Creators control over their home page and their video offerings with the ability to edit, change charities, turn on or turn off these offers at any given time.

Creators will be able to upload and display a number of ‘previously created’ videos to their home page to serve as examples of their video offerings and give consumers an idea of the types of requests available, up to a tailor made video.

The System 1 has the functionality to facilitate the marketing of the Creator's video offerings through their various social media accounts, web sites of their choice and their YouTube page.

The System 1 allows for Creators to be notified when a Consumer has requested a video. The Creator will have the ability to accept, decline, or request additional fees or block the user. If the Creator chooses to decline the video, a ‘decline to produce’ notification is sent to the Consumer. If the Creator chooses to create a video, the Consumer's request description and other pertinent information are made available on the Creator portal page. The Creator portal page is the hub where Creators can action all Consumer requests and track payments. The Creator uploads completed videos on the ‘Creator Video Production’ page. Once a completed video is uploaded and signed off by the Creator, notification is sent to the Consumer.

### Consumers

The embodiment of System 1 would allow Consumers to enter the site through the Homepage where they are exposed to a welcome message and description. Consumers will have the ability to search for specific Creators, types of Creators, or via keywords or tags in their descriptions and bios and language. Searches and web/social media links will generally lead to the Creator homepage.

The Consumer view of a Creator homepage allows the Consumers to view the full array of the Creator's video offerings, along with the prices for each. Consumers are able to browse the Creator's video offerings and view their introductory videos as well as examples of previously recorded and uploaded videos. The Consumer can then ‘click to purchase’ a video offering and request a description of what they would like the creator to produce. This request can be facilitated through text and/or video format. If the Consumer then decides to purchase a personalized video, they will be prompted to create an account, agree to terms and conditions and input payment information.

The System 1 allows for Consumer notifications as to whether the video request has been accepted or declined. If the request has been accepted, payment is made and a link to the video will be made available on the Consumer portal page once the video has been produced and uploaded by the creator. The Consumer portal page will host previously purchased videos for a set period of time. Consumers will have the ability to download and share videos from the Consumer portal page.

The system, in the preferred embodiment, would work like a smartphone or website application, this product would be available through the respective marketplace for smartphones or other computing devices.

### EXAMPLE

### Creator Side

A well known You Tuber, ‘Tui Boy Unicorn’, has amassed over 200,000 subscribers to his YouTube skateboarding channel and many followers on his other social media platforms, gaining celebrity status. He makes some money through advertising and endorsements but would like to supplement that revenue to continue his dream of creating inspiring content. Allocating a few minutes a week to producing some tailored videos for fans while benefiting his favorite charity would help him benefit his chosen charity and give a fan a personalized memory that lasts a lifetime.

### Consumer Side

“Joe, 15, from Ohio loves skateboarding and follows ‘Tui Boy Unicorn’ on YouTube and Instagram. He has always admired the passion and skill that Tui Boy Unicorn’ displays but has never managed to connect with him personally, no matter how hard he tries. One day he reads a post on Tui Boy's Facebook account explaining that he can make personalized videos for his fans and followers that will help support his favorite charity. Joe loves this idea and shows his mom, who orders him a personalized motivational “Keep on skateboarding Joe, you rock!” video message. Joe carries this video on his phone forever!

### Payment Structure

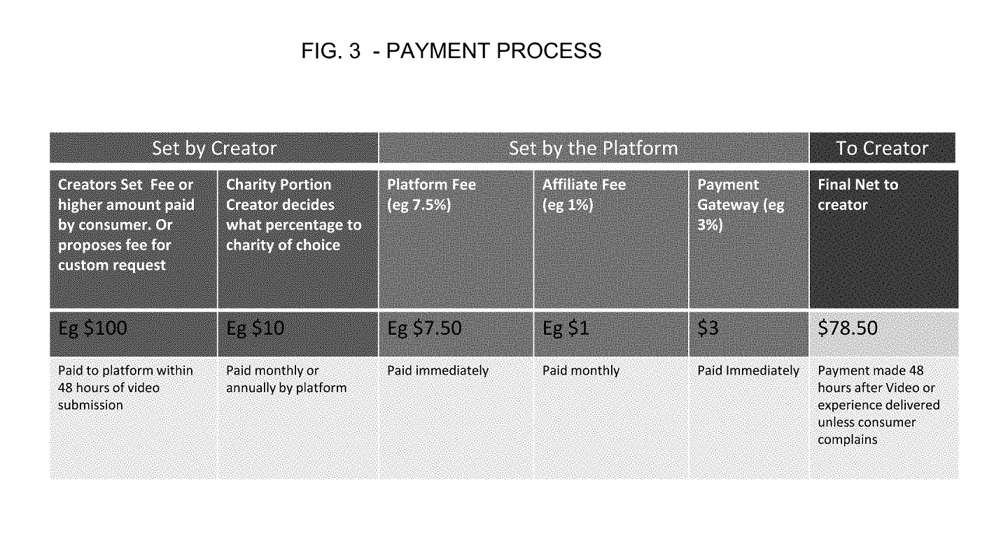

Different payment structures can be used with the system 1 as shown in FIG. 3. The Creators can create a set price for a video experience for themselves and their charity. The system 1 may have different referral fees which can be fixed or based on a percentage of the revenue. All monies are collected by the system and applicable payments such as Charity donation, affiliate fees and payment fees are deducted prior to the balance being paid to the Creator.

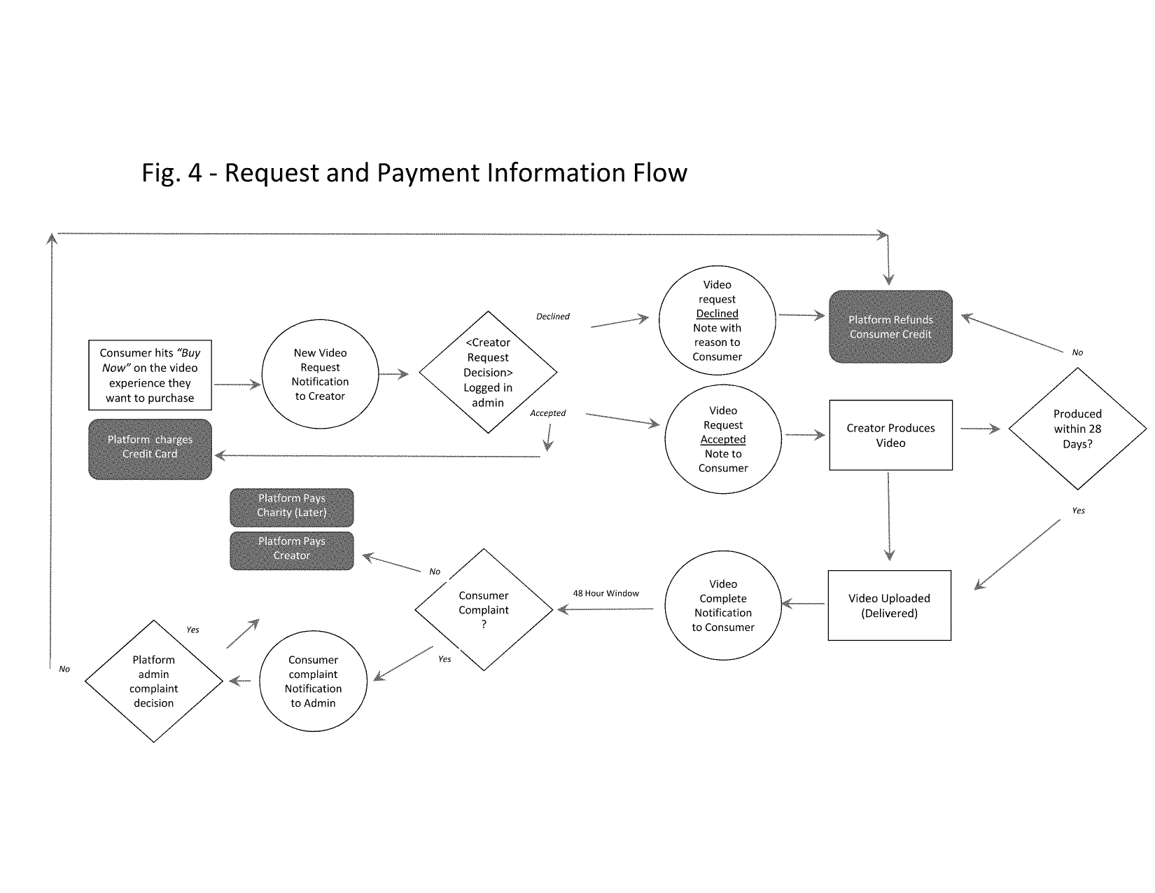

The system's request and payment process flow as shown in FIG. 4. Once the Consumer has created their request, clicked on ‘Buy’, and entered their payment details, the request will be sent by the System 1 via notification to the Creator. Payment will be processed once the Creator has accepted the request. Once the Creator receives the request they will choose to accept or decline it. If they accept it, they will produce and upload a video to the System 1 and a notification will be delivered to the Consumer. Creators may set video delivery times as per their own schedules, up to a maximum turnaround time of 28 days. If turnaround times are not met, the Consumer will be fully refunded.

Payment to the Creator is processed by the System 1 via Paypal within 48 hours after the experience has been delivered to the Consumer, with a fee kept for the System and for processing fees (Platform fee, Affiliate fee, Gateway fee). If there are any disputes within 48 hours of delivery to the Consumer (e.g. incorrect messages, inferior quality etc.) payment to the Creator may be withheld. The matter may be investigated and if the complaint is upheld, a refund may be generated to the Consumer. NOTE: All notifications may take the form of email, text message, in-app notification and website or platform notification.

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system comprising;
having a system that resides in the non-transitory memory of a computing device;
having two groups, group one being creators, group two being consumer where the creators provide experiences to consumers where the creators are famous and the consumers are fans of the creator.

2. The system according to claim 1 where the system is connected to a website.

3. The system according to claim 1 where the system works as a phone application.

4. The system according to claim 1 where the creators offer tailored video messages personalized for the consumer.

5. The system according to claim 1 where the creators will input their profile information.

6. The system according to claim 1 where creators create personalized video

7. The system according to claim 1 where system has payment process.

8. The system according to claim 1 having a creator portal page is the hub where creators can action all consumer requests and track payments.

9. The system according to claim 1 where the consumer has created a request, and entered their payment details, where the request will be sent by the System to the creator.

10. The system according to claim 9 where the payment will be processed once the Creator has accepted the request.
